(19) United States
(12) Patent Application Publication
(10) Pub. No.: US 2003/0185407 A1
(43) Pub. Date: Oct. 2, 2003

(54) Speaker for an electronic instrument

(75) Inventors: Kazumi Miyamoto, Yamanashi-ken (JP); Naoki Miura, Yamanashi-ken (JP)

Correspondence Address: Ira J. Schultz, DENNISON, SCHULTZ & DOUGHERTY, Suite 612, 1745 Jefferson Davis Highway, Arlington, VA, 22202, US

(73) Assignee: Citizen Electronics Co., Ltd.

(21) Appl. No.: 10/377,739

(22) Filed: Mar. 4, 2003

(30) Foreign Application Priority Data
Mar. 27, 2002 (JP) 2002-90057

(51) Int. Cl. H04R 1/02; H04R 25/00; H04R 1/20

(52) U.S. Cl. 381/87; 381/150; 381/340

(57) ABSTRACT

A yoke, a permanent magnet, and a top plate are stacked on a frame in order, and adhered with each other. The frame has a positioning protuberance projected from the frame, and each of the yoke, permanent magnet, and top plate has a central hole and is engaged with the positioning protuberance at the central hole.

### BACKGROUND OF THE INVENTION

The present invention relates to a speaker for generating sounds by vibrating a vibration plate by an electromagnet.

In recent years, there is a tendency to mount small electric parts on a printed circuit board, an electrodynamic speaker for the small electronic instrument is accordingly mounted on the printed circuit board. Such a printed circuit for the portable telephone is used as a signaling device.

Referring to FIGS. 4 and 5, which are a plan view of a conventional electrodynamic speaker and a sectional view taken along a line V-V of FIG. 4, respectively, an electrodynamic speaker 50 has a circular frame 51 having a central circular hole 51b and a projection portion 51a. An annular shoulder 51c is formed on the frame 51 and a pair of cylindrical holes 51d are formed in the projection portion 51a.

A yoke 52 made of magnetic material and having a dish-shape is secured to the wall of the central hole 51b. A disk-shape magnet 53 is secured to the yoke 52 and a disk-shape top plate 54 is securely mounted on the magnet 53. Thus, a magnetic circuit is formed between the yoke 52 and the top plate 54, interposing the magnet 53.

A circular diaphragm 55 made of plastic has a spherical central portion, a circular recess 55a at the periphery of the central portion and a peripheral portion 55b. An annular voice coil 56 is fixed to the underside of the recess 55a and inserted in the gap between the periphery of the top plate 54 and an upper portion of the yoke 52.

A pair of lead plates 57, each of which is made of an elongated metal plate, are embedded in the frame 51. Each of the lead plates 57 is extended between a side wall of the projection portion 51a and an end 57a exposed in the underside of the frame 51. A coil spring 58 is inserted in each hole 51d. An upper end of the coil spring 58 is inserted in a hole formed in an end portion 57b of the lead plate 57 and electrically connected to the lead plate 57 by solder. The lower end of the spring 58 is projected from the underside of the frame 51.

Both ends of the coil 56 are soldered to ends 57a of lead plates 57. Thus, the coil 56 is connected to the coil springs 58.

A cover 59 has sound emanating holes and is adhered to the shoulder 51c. The coil springs 58 are pressed against a circuit pattern on a substrate.

In the above described speaker, it is necessary to exactly assemble the yoke 52 and the top plate 54 to form the magnetic gap having a uniform width at a predetermined position.

Hereinafter, a conventional assembling method for the speaker will be described.

Referring to FIG. 6, there is provided an assembling jig 61 having a heavy weight. The assembling jig 61 has a cylindrical projection 61a on the underside thereof. The outside of the cylindrical projection 61a is adapted to be engaged with the inside of the yoke 52, and the inside of the projection 61a is adapted to be engaged with the outside of the magnet 53.

An adhesive is coated on either of contact surface of the yoke 52 and magnet 53, and the yoke and magnet are engaged with the cylindrical projection 61a. The yoke and magnet are pressed to each other by the weight of the jig 62 and adhered with the adhesive.

In the engagement, it is necessary to provide a clearance in each engagement portion. For example, the tolerance of the outer diameter of the magnet 53 is set to φD1−0.1 mm, the tolerance of the inner diameter of the cylindrical projection 61a is set to φD2−0.025 mm, that of the yoke 52 is φD2+0.025 mm, and the tolerance of the outer diameter of the cylindrical portion 61a is φD2−0.025 mm.

Next, the mounting of the top plate 54 on the magnet 53 will be described.

Referring to FIG. 7, a heavy jig 62 has a cylindrical projection 62a on the underside thereof. The top plate 54 is mounted on the magnet interposing an adhesive there-between. Then the jig 62 is mounted on the yoke 52 and the magnet 53, inserting the cylindrical projection 62a in the gap between the yoke 52 and the top plate 54. Thus, the top plate is secured to the magnet 53 with the adhesive by the weight of the jig 62.

Tolerance of the assembly are set to the above described values. Namely, these values are φD3−0.1 mm, φD2−0.025 mm, D2+0.025 mm and φD2−0.025 mm.

However, since there are clearances in the assembly, a maximum diametrical deflection of 0.15 mm (=0.1+0.025+0.025) may occur. The deflection causes the deflection of the magnetic gap, which causes the coil 50 to contact with the yoke 52 or top plate 54 and to upset the vibrating balance of the diaphragm 55. In addition, there is a problem that the adhesion strength with adhesive between members of the assembly is weak.

### SUMMARY OF THE INVENTION

An object of the present invention is to provide a speaker having a positioning means of high accuracy in an assembly of the yoke, magnet and top plate, and having a high engagement strength.

According to the present invention, there is provided a speaker having a frame on which a yoke, a permanent magnet, and a top plate are stacked in order, and adhered with each other, wherein the frame has a positioning protuberance projected from the frame, and each of the yoke, permanent magnet, and top plate has a central hole and is engaged with the positioning protuberance at the central hole.

The top of the protuberance is riveted.

These and other objects and features of the present invention will become more apparent from the following detailed description with reference to the accompanying drawings.

### BRIEF DESCRIPTION OF DRAWINGS

FIG. 1a is a plan view of a speaker of the present invention;

FIG. 1b is a sectional view of the speaker taken along a line I-I of FIG. 1;

FIG. 2 is a sectional view of a main part of the speaker;

FIG. 3 is a sectional view for explaining the assembling of the main part;

FIG. 4 is a plan view of a conventional electrodynamic speaker;

FIG. 5 is a sectional view taken along a line V-V of FIG. 4;

FIGS. 6 and 7 are sectional views for explaining the assembling of a main part of the speaker.

### DETAILED DESCRIPTION OF THE PREFERRED EMBODIMENT

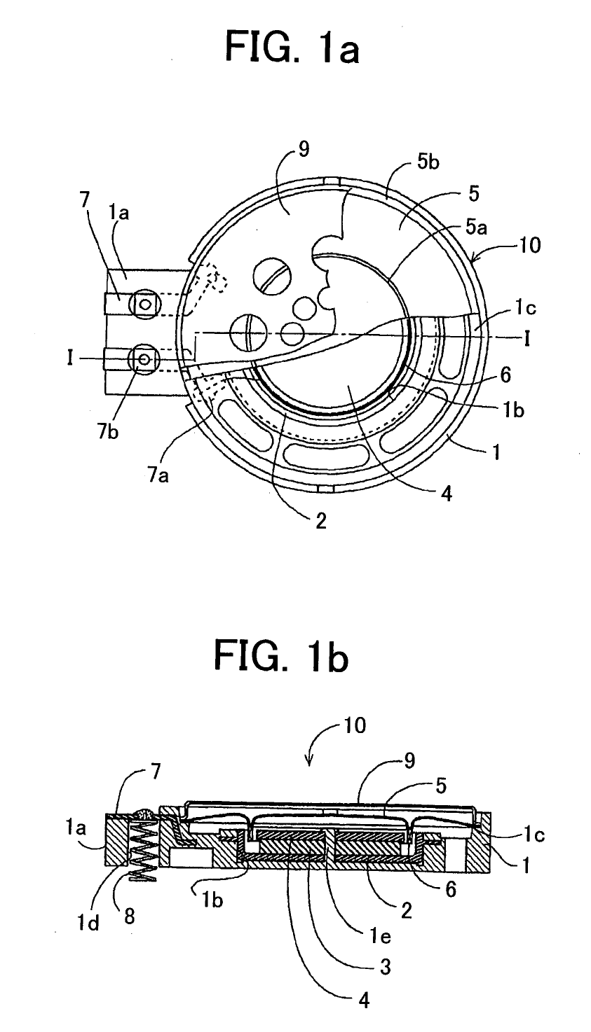

Referring to FIGS. 1a and 1b, an electrodynamic speaker 10 has a circular frame 1 made of plastic and having a central circular recess 1b, a projection portion 1a, and a positioning protuberance 1e projected from a central position of the circular recess 1b. An annular shoulder 1c is formed on the frame 1 and a pair of cylindrical holes 1d are formed in the projection portion 1a.

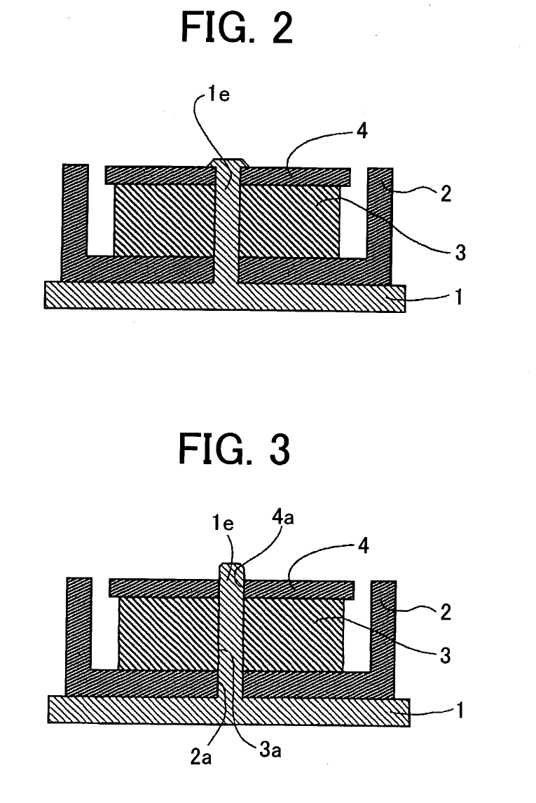

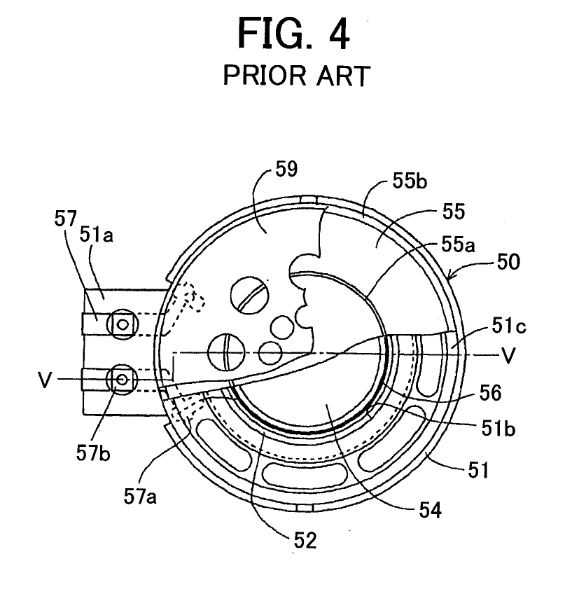

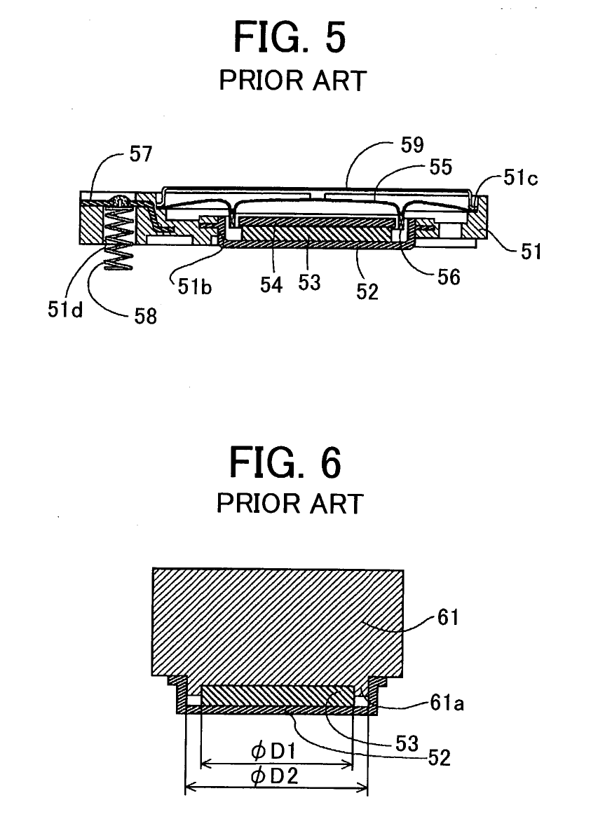

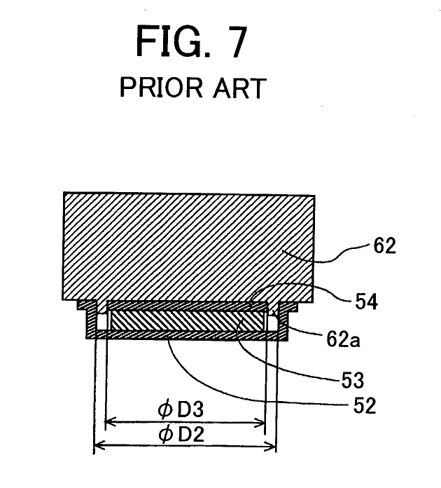

Referring to FIG. 3, a yoke 2 made of magnetic material and having a dish-shape has a central hole 2a to be engaged with the protuberance 1e of the frame 1. A disk-shape permanent magnet 3 and a disk-shape top plate 4 have also central holes 3a and 4a respectively. The yoke 2, magnet 3 and the plate 4 are stacked on the central hole 1b of the frame 1, engaging the central holes 2a, 3a and 4a with the protuberance 1e and adhered with each other by adhesive. The top of the protuberance 1e is riveted as shown in FIG. 2, so that the yoke 2, magnet 3 and top plate 4 are secured to the frame 1.

A circular diaphragm 5 made of plastic has a spherical central portion, a circular recess 5a at the periphery of the central portion and a peripheral portion 5b. An annular voice coil 6 is fixed to the underside of the recess 5a and inserted in the gap between the periphery of the top plate 4 and an upper portion of the yoke 2.

A pair of lead plates 7, each of which is made of an elongated metal plate, are embedded in the frame 1. Each of the lead plates 7 is extended between a side wall of the projection portion 1a and an end 7a exposed in the underside of the frame 1. A coil spring 8 is inserted in each hole 1d. An upper end of the coil spring 8 is inserted in a hole formed in an end portion 7b of the lead plate 7 and electrically connected to the lead plate 7 by solder. The lower end of the spring 8 is projected from the underside of the frame 1.

Both ends of the coil 6 are soldered to ends 7a of lead plates 7. Thus, the coil 6 is connected to the coil springs 8.

A cover 9 has sound emanating holes and is adhered to the shoulder 1c. The coil springs 8 are pressed against a circuit pattern on a substrate.

In accordance with the present invention, the yoke, permanent magnet, and top plate are positioned by the positioning protuberance projected from the frame. Therefore, it is not necessary to provide assembling jigs. Further, since the yoke, magnet and top plate are secured to the frame at the same time, the assembling operation becomes simple. In addition, since the assembled members are fixed by the riveted protuberance, the assembly is not disassembled by shocking.

While the invention has been described in conjunction with preferred specific embodiment thereof, it will be understood that this description is intended to illustrate and not limit the scope of the invention, which is defined by the following claims.

What is claimed is:

1. A speaker having a frame on which a yoke, a permanent magnet, and a top plate are stacked in order, and adhered with each other;
wherein the frame has a positioning protuberance projected from the frame; and
each of the yoke, permanent magnet, and top plate has a central hole and is engaged with the positioning protuberance at the central hole.

2. The speaker according to claim 1 wherein the top of the protuberance is riveted.
